(19) United States
(12) Patent Application Publication
(10) Pub. No.: US 2025/0368803 A1
(43) Pub. Date: Dec. 4, 2025

(54) RUBBER COMPOSITION COMPRISING AN ESTOLIDE AS BIO-SOURCED PLASTICIZER

(71) Applicant: COMPAGNIE GENERALE DES ETABLISSEMENTS MICHELIN, Clermont-Ferrand (FR)

(72) Inventors: ARNAUD RODRIGUES, Clermont-Ferrand (FR); ANGELIQUE PAWLAK, Clermont-Ferrand (FR); SALVATORE PAGANO, Clermont-Ferrand (FR)

(21) Appl. No.: 18/876,699

(22) PCT Filed: Jun. 29, 2023
(86) PCT No.: PCT/EP2023/067796

§ 371 Date: Dec. 19, 2024

(30) Foreign Application Priority Data
Jun. 30, 2022 (FR) FR2206662

(51) Int. Cl. C08K 5/103; C08C 19/00; C08J 3/24; C08K 3/36

(52) U.S. Cl. CPC C08K 5/103; C08C 19/00; C08J 3/24; C08K 3/36

(57) ABSTRACT

The present invention relates to a rubber composition based on at least one elastomer matrix, a reinforcing filler, a vulcanization system and a plasticizing system comprising at least one estolide having a weight-average molar mass (Mw) of less than 5000 g/mol as biobased plasticizer.

### TECHNICAL FIELD

The present invention relates to rubber compositions intended in particular for the manufacture of rubber articles such as tyres or semi-finished products for tyres. In particular, the invention is concerned with such rubber compositions, comprising an estolide as plasticizer, which may be entirely or partially biobased.

In the current context of saving energy and preserving the environment, manufacturers are constantly looking for new renewable sources that can be used as starting materials for the manufacture of products.

For this purpose, tyre manufacturers are seeking to reduce the environmental impact of the manufacture of tyres and their use.

The reduction in the hysteresis of the rubber compositions used for the manufacture of tyres is a constant, long-term objective of designers in order to obtain tyres having a reduced rolling resistance in order to limit fuel consumption.

Among the levers available likewise to tyre designers is the gradual replacement of fossil resource-derived materials with sustainable materials. Materials of biobased origin constitute a portion of these sustainable materials. However, the replacement of petroleum-derived products in the constituent compositions of the tyre with products of biobased origin should not be carried out to the detriment of the expected safety and performance qualities. Thus, the products of biobased origin used in the tyre must be technically as efficient as the products prepared from starting materials of fossil origin.

There is an abundant literature relating to the replacement of liquid plasticizers of fossil origin in rubber compositions intended for the manufacture of tyres, with biobased oils derived from vegetable oils, for instance tall oil, sunflower oil, linseed oil or castor oil.

Finding alternatives to the use of plasticizers of fossil origin is thus a major concern for designers of materials intended for the manufacture of tyres, while maintaining the hysteresis of these materials, in order to limit the environmental impacts of the tyres.

Thus, the technical problem to be addressed is that of providing a rubber composition for a tyre which contributes to reducing its environmental footprint while maintaining its performance, in particular the hysteresis. More particularly, one objective of the present invention is to provide a rubber composition comprising an at least partially biobased plasticizing system, while ensuring the maintenance of the hysteresis properties of the composition and thus of the tyre performance.

### Disclosure of the Invention

The applicant has discovered, surprisingly, that the replacement, in a rubber composition, of the petroleum-derived oil with an estolide makes possible not only the use of a biobased plasticizer, but also a substantial reduction in the tan delta max value at 23° C., tan delta max being a descriptor of the hysteresis of the composition, a property which contributes to the rolling resistance.

### SUMMARY OF THE INVENTION

A subject of the invention is thus a rubber composition based on at least one elastomer matrix, a reinforcing filler, a crosslinking system and a plasticizing system, which plasticizing system comprises an estolide having a weight-average molar mass (Mw) of less than 5000 g/mol.

A subject of the invention is particularly a rubber composition according to any one of the following embodiments:
1. Rubber composition based on at least:
an elastomer matrix,
40 to 200 phr of a reinforcing filler,
10 to 140 phr of a plasticizing system comprising at least one estolide with a weight-average molar mass (Mw) of less than 5000 g/mol determined by SEC, size exclusion chromatography described in the description,
a crosslinking system.
2. Composition according to the preceding embodiment, in which the elastomer matrix comprises at least one diene elastomer selected from the group consisting of polybutadienes, natural rubber, synthetic polyisoprenes, butadiene copolymers, isoprene copolymers and mixtures of these elastomers.
3. Composition according to any one of the preceding embodiments, in which the elastomer matrix comprises at least one butadiene elastomer selected from the group consisting of polybutadienes and butadiene copolymers and mixtures of these elastomers, preferably at least one copolymer of butadiene and of styrene.
4. Composition according to any one of the preceding embodiments, in which the elastomer matrix predominantly comprises at least one butadiene elastomer, preferably at least one copolymer of butadiene and of styrene.
5. Composition according to any one of the preceding embodiments, in which the reinforcing filler comprises silica, carbon black or a mixture of silica and carbon black.
6. Composition according to any one of the preceding embodiments, in which the reinforcing filler predominantly comprises silica in a content within a range extending from 40 phr to 120 phr, preferably ranging from 60 to 120 phr.
7. Composition according to any one of the preceding embodiments, in which the content of the at least one estolide is within a range extending from 5 to 70 phr, preferably from 10 to 50 phr.
8. Composition according to any one of the preceding embodiments, in which the plasticizing system comprises from 10% to 100% by weight of at least one estolide, preferably from 15% to 70% by weight, relative to the total weight of the plasticizing system.
9. Composition according to any one of the preceding embodiments, in which the at least one estolide is an estolide of a linear or branched, saturated or unsaturated C₈ to C₃₄ fatty acid, esterified with a fatty alcohol or a diol dimer.
10. Composition according to any one of the preceding embodiments, in which the at least one estolide is an estolide of a linear or branched, saturated or unsaturated C₁₂ to C₂₂, in particular C₁₆ to C₂₀ and more particularly C₁₈ hydroxy fatty acid.
11. Composition according to any one of the preceding embodiments, in which the at least one estolide is an estolide of ricinoleic acid.
12. Composition according to any one of the preceding embodiments, in which the estolide is an estolide esterified with a linear or branched, saturated or unsaturated C₈ to C₃₄ fatty alcohol.
13. Composition according to any one of the preceding embodiments, in which the estolide is an estolide esterified with a fatty alcohol having a branched aliphatic C₁₂ to C₂₂, in particular C₁₆ to C₂₀ and more particularly C₁₈ carbon chain.
14. Composition according to any one of the preceding embodiments, in which the estolide is an estolide esterified with isostearyl alcohol.
15. Composition according to any one of embodiments 1 to 11, in which the estolide is an estolide esterified with a diol dimer.
16. Composition according to any one of embodiments 1 to 11, in which the estolide is an estolide esterified with a saturated or unsaturated alicyclic diol dimer.
17. Composition according to any one of embodiments 1 to 11, in which the estolide is an estolide esterified with a C₃₆ diol dimer, which is preferably saturated.
18. Composition according to any one of the preceding claims, in which the estolide corresponds to formula I:

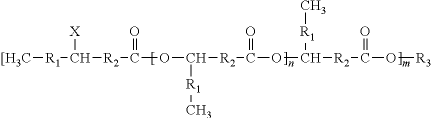

in which:
n represents an integer ranging from 1 to 5, preferably from 1 to 3;
m is equal to 1 or 2;
X is a hydrogen atom H or a hydroxyl group —OH;
R₁, which may be identical or different, represent linear or branched, saturated or unsaturated, divalent aliphatic C₁-C₂₀ radicals, preferentially the R₁ are identical;
R₂, which may be identical or different, are linear or branched, saturated or unsaturated, divalent aliphatic C₁-C₂₀ radicals, preferentially the R₂ are identical;
the number of carbons in each fatty acid unit being within a range extending from 8 to 34, preferably from 12 to 22, even more preferably from 18;
when m is 1, R₃ represents H (hydrogen atom) or a linear or branched, saturated or unsaturated aliphatic C₁₂ to C₂₂, in particular C₁₆ to C₂₀ and more particularly C₁₈, group;
when m is 2, R₃ represents a cyclic or acyclic, saturated or unsaturated, divalent aliphatic, especially C₂₄ to C₄₄, in particular C₃₂ to C₄₀ and more particularly C₃₆, group.
19. Composition according to the preceding embodiment, in which, in formula I, the number of carbons in each fatty acid unit is within a range extending from 16 to 20, in particular 18.
20. Composition according to either one of embodiments 18 and 19, in which, in formula I, X represents a hydroxyl group —OH.
21. Composition according to any one of embodiments 18 to 20, in which, in formula I, m is 1 and R₃ represents a branched saturated aliphatic C₁₆ to C₂₀ and more particularly C₁₈ group.
22. Composition according to any one of embodiments 18 to 20, in which, in formula I, m is 2 and R₃ represents a saturated or unsaturated, preferably saturated, divalent alicyclic C₃₂ to C₄₀ and more particularly C₃₆ group.
23. Composition according to any one of the preceding embodiments, in which the at least one estolide is an estolide of ricinoleic acid esterified with isostearyl alcohol or an estolide of ricinoleic acid esterified with a saturated alicyclic C₃₆ diol dimer.

Another subject of the invention is finished or semi-finished rubber articles comprising a rubber composition in accordance with the invention according to any one of the preceding embodiments.

The invention also relates to a tyre, one of the constituent elements of which comprises a composition according to any one of the preceding embodiments.

More particularly, a subject of the invention is also a tyre, the tread of which comprises a composition according to any one of the preceding embodiments.

### Definitions

The expression “part by weight per hundred parts by weight of elastomer” (or phr) should be understood as meaning, within the meaning of the present invention, the part by weight per hundred parts by weight of elastomer or rubber.

In the present document, unless expressly indicated otherwise, all the percentages (%) indicated are percentages (%) by weight.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

In the present document, the expression composition “based on” is intended to mean a composition comprising the mixture or the reaction product of the various constituents used, some of these base constituents being capable of reacting or intended to react with one another, at least in part, during the various phases of manufacture of the composition, in particular during the crosslinking or vulcanization thereof. By way of example, a composition based on an elastomer matrix and on sulfur comprises the elastomer matrix and the sulfur 20 before curing, whereas, after curing, the sulfur has reacted with the elastomer matrix with the formation of sulfur (polysulfide, disulfide, monosulfide) bridges.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Preferentially, this is the compound which represents, for example, more than 50%, 60%, 70%, 80%, 90%, or even 100% by weight relative to the total weight of the type of compound. Thus, for example, a predominant reinforcing filler is the reinforcing filler representing the greatest weight relative to the total weight of the reinforcing fillers in the composition. In contrast, a “minor” compound is a compound which does not represent the greatest fraction by weight among the compounds of the same type.

The compounds mentioned in the description may be of fossil origin or be biobased. In the latter case, they may be partially or completely derived from biomass or obtained from renewable starting materials derived from biomass. In the same way, the compounds mentioned can also originate from the recycling of pre-used materials, that is to say that they can, partially or completely, result from a recycling process, or else be obtained from starting materials which themselves result from a recycling process. This notably concerns polymers, plasticizers, fillers, etc.

### DETAILED DESCRIPTION OF THE INVENTION

### I.1. Elastomer Matrix

The rubber composition according to the invention comprises an elastomer matrix, which matrix is usually based on at least one diene elastomer.

The term “diene elastomer” should be understood, in a known way, as meaning an (one or more is understood) elastomer resulting at least in part (i.e., a homopolymer or a copolymer) from diene monomers.

The term “diene elastomer capable of being used in the compositions in accordance with the invention” is understood in particular to mean:
(a)—any homopolymer of a conjugated diene monomer having from 4 to 18 carbon atoms;
(b)—any copolymer of a conjugated diene having from 4 to 18 carbon atoms and of at least one other monomer. The other monomer may be ethylene, a vinylaromatic compound or another diene.

Suitable as conjugated diene is a conjugated diene having from 4 to 12 carbon atoms, in particular a 1,3-diene, such as in particular 1,3-butadiene, isoprene, a 2,3-di (C₁-C₅ alkyl)-1,3-butadiene and 1,3-pentadiene, and also 2,4-hexadiene. As conjugated dienes, 1,3-butadiene and isoprene are most particularly suitable.

A vinylaromatic compound having from 8 to 20 carbon atoms is suitable as vinylaromatic compound. In this respect, the following are for example suitable: styrene, ortho-, meta-or para-methylstyrene, the “vinyltoluene” commercial mixture, para-(tert-butyl) styrene, methoxystyrenes, chlorostyrenes, vinylmesitylene, divinylbenzene or vinylnaphthalene. Styrene is most particularly suitable as vinylaromatic compound.

The copolymers can comprise between 99% and 20% by weight of diene units and between 1% and 80% by weight of vinylaromatic units.

The diene elastomer may have any microstructure, which depends on the polymerization conditions used, especially on the presence or absence of a modifying and/or randomizing agent and on the amounts of modifying and/or randomizing agent employed. The elastomer may be, for example, a block, random, sequential or microsequential elastomer and may be prepared in dispersion or in solution.

The diene elastomer may be coupled and/or star-branched, or else functionalized with a coupling and/or star-branching or functionalizing agent.

The diene elastomer can be simultaneously or alternatively functionalized and can comprise at least one functional group. The term “functional group” is understood to mean a group comprising at least one heteroatom selected from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

Preferentially, the elastomer matrix according to the invention comprises at least one diene elastomer selected from the group consisting of polybutadienes (BRs), natural rubber (NR), synthetic polyisoprenes (IRs), butadiene copolymers, isoprene copolymers and the mixtures of these elastomers. Such copolymers are more preferentially selected from the group consisting of butadiene-styrene copolymers (SBR), isoprene-butadiene copolymers (BIR), isoprene-styrene copolymers (SIR), isoprene-butadiene-styrene copolymers (SBIR), butadiene-acrylonitrile copolymers (NBR), butadiene-styrene-acrylonitrile copolymers

(NSBR), ethylene-butadiene copolymers (EBR) and terpolymers of ethylene, butadiene and another conjugated diene monomer, notably isoprene, myrcene or farnesene, or a mixture of two or more of these compounds.

The compositions of the invention can comprise just one diene elastomer or a mixture of several diene elastomers.

According to a preferred implementation of the invention, the elastomer matrix comprises at least one butadiene elastomer. This should be understood as meaning one or more butadiene elastomers.

Preferentially, according to this implementation, the elastomer matrix predominantly comprises at least one butadiene elastomer. More preferentially still, the content of butadiene elastomer(s) is from 30 to 100 phr, more preferentially from 50 to 100 phr, more preferentially from 80 to 100 phr.

The term “butadiene elastomer” is understood to mean, in a known way, a butadiene homopolymer or copolymer; in other words, a diene elastomer selected from the group consisting of polybutadienes (BRs), butadiene copolymers, the butadiene copolymer is as listed above, and mixtures thereof. The butadiene copolymers are particularly selected from the group consisting of copolymers of butadiene and of styrenes (SBRs). Preferably, the butadiene elastomer is selected from the group consisting of copolymers of butadiene and of styrenes (SBRs) and mixtures thereof.

### I.2. Plasticizing System

The composition according to the invention from 10 to 140 phr of a plasticizing system comprising at least one estolide with a weight-average molar mass Mw of less than 5000 g/mol and preferably within a range extending from 700 to 5000 g/mol, more preferably within a range extending from 700 to 3500 g/mol.

The weight-average molar mass (Mw) of the estolides is measured by SEC (size exclusion chromatography) according to the method described below.

According to the invention, the expression “at least one estolide” means one or more estolides.

According to embodiments of the invention, the plasticizing system comprises from 10% to 100% by weight of at least one estolide, preferably from 15% to 70% by weight, relative to the total weight of the plasticizing system. The expression “at least one estolide” is intended to denote an estolide or several estolides (that is to say a mixture of estolides).

According to the invention, the rubber composition preferably comprises from 5 to 70 phr, more preferentially from 10 to 50 phr of at least one estolide.

### Estolides

Estolides are obtained from unsaturated fatty acids and/or saturated fatty acids. Estolides are a class of esters that are 100% biobased when the fatty acids are of natural origin. The oligomer structure of the estolides contains fatty acid repeating units, each unit of a fatty acid being esterified by another fatty acid unit. Document WO2012173671A1 describes such compounds.

Certain estolides can be obtained from fatty acids that are naturally hydroxylated or from fatty acids which have undergone hydroxylation, the hydroxyl function of each unit of a fatty acid is esterified by the acid function of another fatty acid. According to other synthesis methods, the estolide will be formed by production of a carbocation at the site of unsaturation of an unsaturated fatty acid, followed by nucleophilic attack on the carbocation by the carboxylic group of another fatty acid. As starting compound, use may be made of the fatty acid or the alkyl ester thereof, some being commercially available. These synthesis methods are known and are within the scope of a person in the art. For example, document WO2012173671A1 describes methods for synthesizing estolides.

The reader will understand that, in order to reduce the environmental impact of the rubber composition according to the invention, a fatty acid is very preferentially understood to mean a fatty acid of natural origin, obtained by hydrolysis of vegetable oils, such as, to mention but a few examples, the fatty acids of: orange oil, avocado oil, macadamia oil, olive oil, hydrogenated soybean oil, rapeseed oil, jojoba oil, palm oil, castor oil, wheat germ oil, saffron oil, linseed oil, safflower oil, maize oil, pine oil, sunflower oil, coconut oil, peanut oil, grape seed oil, cottonseed oil, macadamia oil and mixtures thereof.

Among the fatty acids of natural origin, examples that may be mentioned include:
saturated linear fatty acids such as caprylic acid, capric acid, lauric acid, myristic acid, palmitic acid, stearic acid, arachidic acid, behenic acid, lignoceric acid, cerotic acid,
saturated or unsaturated branched fatty acids are fatty acids bearing a methyl group attached to the penultimate or antepenultimate carbon atom or several methyl groups distributed along the chain, for instance isostearic acid or isopalmic acid,
unsaturated, linear fatty acids, such as linderic acid, myristoleic acid, palmitoleic acid, oleic acid, linoleic acid, elaidic acid, gadolenoic acid, eicosapentaenoic acid, docosahexaenoic acid, erucic acid, brassidic acid, arachidonic acid,
hydroxy fatty acids such as ricinoleic acid, hydroxystearic acids.

According to the invention, the term “fatty acid” is understood to denote a linear or branched, saturated or unsaturated C₈ to C₃₄, notably C₈ to C₂₆, notably C₁₂ to C₂₂ in particular C₁₆ to C₂₂ fatty acid. According to preferred embodiments of the invention, the fatty acid is a linear or branched, saturated or unsaturated C₁₂ to C₂₂, in particular C₁₆ to C₂₀ and more particularly C₁₈ hydroxy fatty acid. More preferentially, the fatty acid is ricinoleic acid.

According to preferred embodiments of the invention, the estolide is an estolide which has undergone ultimate esterification with a linear or branched, saturated or unsaturated C₁ to C₃₄ aliphatic alcohol, preferably a fatty alcohol, or a diol dimer, which fatty alcohol and diol dimer are defined below. In the context of the invention, such an esterified estolide is also denoted by the name “estolide”.

According to the invention, the expression “fatty alcohol” is intended to denote an alcohol obtained by catalytic hydrogenation of a linear or branched, saturated or unsaturated C₈ to C₃₄, notably C₈ to C₂₆, notably C₁₂ to C₂₂, in particular C₁₆ to C₂₂ and more particularly C₁₈ fatty acid.

The fatty alcohol may be a saturated or unsaturated linear C₈ to C₃₄ fatty alcohol, preferably a linear C₈ to C₂₆, notably C₁₂ to C₂₂ and more particularly C₁₈ fatty alcohol, like stearyl alcohol, oleyl alcohol and linoleyl alcohol, for example.

The fatty alcohol may be a branched fatty alcohol. According to the invention, the expression “branched fatty alcohol” is intended to denote an alcohol derived from a fatty acid having a methyl group attached to the penultimate or antepenultimate carbon atom or several methyl groups distributed along the chain. These branched fatty alcohols are preferably C₁₂ to C₂₂ and more particularly C₁₈ fatty alcohols, like isostearyl alcohol.

According to the invention, the term “diol dimer” is likewise understood to denote a diol produced by catalytic hydrogenation of the acid functions of a dicarboxylic acid dimer, itself obtained by dimerization of a linear or branched, preferably unsaturated, fatty acid, especially C₁₂ to C₂₂, in particular C₁₆ to C₂₀ and more particularly C₁₈ fatty acid, such as, for example, oleic acid, linoleic acid and a-linoleic acid, and a mixture thereof. Dimerized fatty acids are commercially available, for example under the name Pripol (Pripol 1013, Pripol 1009, Pripol 1017, etc.) by Croda. The diol dimers that may be used in the context of the invention may be synthesized conventionally. The diol dimers that can be used in the context of the invention are also available commercially. Examples that may be mentioned include the C₃₆ diol dimers sold under the name Pripol 2033, Pripol 2043 and Pripol 2013 by Croda.

According to embodiments of the invention, the diol dimer derived from a dimerized fatty acid is aliphatic, cyclic or acyclic, and saturated or unsaturated. The term “cyclic” means a monocyclic or polycyclic diol dimer, i.e. one comprising one or more aliphatic rings in its structure. According to particular embodiments of the invention, the diol dimer is a saturated or unsaturated, preferably saturated, alicyclic (aliphatic and cyclic) C₃₆ diol dimer.

Preferentially, according to these embodiments of the invention, the estolide is an estolide which has undergone an ultimate esterification with a C₈ to C₂₆, in particular C₁₂ to C₂₂ and more particularly C₁₈ fatty alcohol, like isostearyl alcohol.

Alternatively, preferentially according to these embodiments of the invention, the estolide is an estolide which has undergone an ultimate esterification with a diol dimer, more preferentially a C₃₆ diol dimer. According to the invention, the at least one estolide is preferably a compound of formula I:

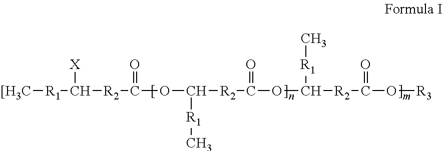

in which:
n represents an integer ranging from 1 to 5, preferably from 1 to 3;
m is equal to 1 or 2;
X is a hydrogen atom or an —OH group;
R₁, which may be identical or different, represent linear or branched, saturated or unsaturated, divalent aliphatic C₁-C₂₀ radicals, preferentially the R₁ are identical;
R₂, which may be identical or different, are linear or branched, saturated or unsaturated, divalent aliphatic C₁-C₂₀ radicals, preferentially the R₂ are identical;
the number of carbons in each fatty acid unit being within a range extending from 8 to 34, preferably from 12 to 22, more preferentially from 16 to 20, in particular 18;
when m is equal to 1, R₃ represents H (hydrogen atom) or a linear or branched, saturated or unsaturated aliphatic C₈-C₃₄ group, preferably an aliphatic C₈ to C₂₆, more preferably C₁₂ to C₂₂, in particular C₁₆ to C₂₀ and more particularly C₁₈ group;
when m is 2, R₃ represents a cyclic or acyclic, saturated or unsaturated, divalent aliphatic C₂₄ to C₄₄, in particular C₃₂ to C₄₀ and more particularly C₃₆ group.

According to variants of the invention, in formula I, the at least one from among R₁ and R₂ is a linear or branched, unsaturated divalent aliphatic radical comprising at least one carbon-carbon double bond.

According to preferred variants of the invention, the number of carbons in each fatty acid unit is within a range extending from 16 to 20 and is in particular 18. “Fatty acid unit” is understood to mean the unit of formula II:

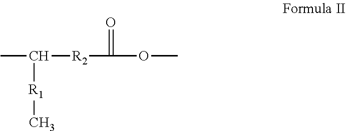

According to variants of the invention, the estolide may be a compound obtained from a hydroxy fatty acid. According to these variants, in formula I, X represents an —OH group. Mention may be made, as hydroxy fatty acids, of ricinoleic acid or hydroxy stearic acids.

According to one of these variants of the invention, the estolide is preferably a compound obtained from ricinoleic acid. Advantageously, such an estolide is obtained from castor oil comprising a mass fraction at least equal to 80% of ricinoleic acid.

According to variants of the invention, the estolide may be a compound obtained from a fatty acid, optionally a hydroxy fatty acid, which has undergone esterification with an aliphatic alcohol, preferably a fatty alcohol. According to these variants of the invention, R₃ is preferably the carbon chain derived from a fatty alcohol and represents a saturated or unsaturated, linear or branched C₈-C₃₄, in particular C₈ to C₂₆, in particular C₁₂ to C₂₂, in particular C₁₆ to C₂₀ and more particularly C₁₈ aliphatic radical.

According to variants of the invention, the estolide may be a compound obtained from a fatty acid, optionally a hydroxy fatty acid, which has undergone esterification with a diol dimer. According to these variants of the invention, R₃ is preferably the carbon chain derived from a diol dimer and represents a cyclic or acyclic, saturated or unsaturated, divalent aliphatic C₂₄ to C₄₄, in particular C₃₂ to C₄₀ and more particularly C₃₆ group. More preferentially then, R₃ represents a cyclic divalent aliphatic C₃₆ group which is preferably saturated.

According to variants of the invention, the estolide is preferably a compound obtained from a hydroxy fatty acid, preferentially ricinoleic acid, which has undergone esterification with a branched C₁₂ to C₂₂ and more particularly C₁₈ fatty alcohol, preferentially isostearyl alcohol, or with an alicyclic C₃₆ diol dimer.

Advantageously, the ricinoleic acid is obtained from castor oil.

### Other Plasticizers

According to some embodiments of the invention, the plasticizing system consists essentially of at least one estolide.

Thus, according to certain embodiments of the invention, the plasticizing system may comprise one or more other plasticizing compounds customarily used in rubber compositions for tyres. These other plasticizing compounds may be selected from plasticizing hydrocarbon resins and plasticizers that are liquid at ambient temperature (around 23° C.) customarily used in rubber compositions for tyres.

By way of examples of hydrocarbon resins that can be used in the context of the invention, mention may be made of those selected from the group consisting of cyclopentadiene (abbreviated to CPD) or dicyclopentadiene (abbreviated to DCPD) homopolymer or copolymer resins, terpene homopolymer or copolymer resins, C₅ fraction homopolymer or copolymer resins, C₉ fraction homopolymer or copolymer resins (or more generally of a C₈-C₁₀ fraction), coumarone homopolymer or copolymer resins, rosin esters and mixtures of these resins. Mention may more particularly be made, among the above copolymer resins, of those selected from the group consisting of terpene copolymers, (D)CPD/C₉ aromatic copolymer resins, (D)CPD/terpene copolymer resins, (D)CPD/Cs fraction copolymer resins, terpene/vinylaromatic copolymer resins, C₅/C₉ fraction copolymer resins and the mixtures of these resins.

The term “terpene” groups together here, in a known manner, in particular α-pinene, β-pinene and limonene monomers. Suitable as C₉ monomer are, for example: styrene, phenol, α-methylstyrene, ortho-, meta- or para-methylstyrene, vinyltoluene, para-(tert-butyl) styrene, methoxystyrenes, chlorostyrenes, vinylmesitylene, divinylbenzene, vinylnaphthalene, indene or any vinylaromatic monomer resulting from a C₉ fraction (or more generally from a C₈ to C₁₀ fraction).

As examples of liquid plasticizers that can be used in the context of the invention, mention may be made of those selected from liquid diene polymers, polyolefin oils, naphthenic oils, paraffinic oils, DAE oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulfonate plasticizers and mixtures of these compounds.

The reader will understand that, in order to reduce the environmental impact of the rubber composition according to the invention, if at least one other plasticizer is used in the rubber composition, the latter will preferably be of a renewable nature, in particular of biobased origin.

### I.3. Reinforcing Filler

The rubber composition of the invention comprises from 40 to 200 phr of total reinforcing filler. The rubber composition of the invention can comprise one or more reinforcing fillers.

Use may be made of any type of “reinforcing” filler known for its abilities to reinforce a rubber composition which can be used in particular for the manufacture of tyres, for example an organic filler, such as carbon black, an inorganic filler, such as silica, or also a mixture of these two types of fillers. Suitable as carbon blacks are all carbon blacks, in particular the blacks conventionally used in tyres or their treads. Among the latter, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 or N772 blacks. These carbon blacks can be used in the isolated state, as commercially available, or in any other form, for example as support for some of the rubber additives used. The carbon blacks might, for example, be already incorporated into the diene elastomer, notably isoprene elastomer, in the form of a masterbatch (see, for example, patent applications WO 97/36724-A2 and WO 99/16600-A1). Mineral fillers of the siliceous type, preferentially silica (SiO₂), or of the aluminous type, especially alumina (Al₂O₃), are suitable in particular as reinforcing inorganic fillers. The silica used may be any reinforcing silica known to a person in the art, notably any precipitated or fumed silica with a BET specific surface area and also a CTAB specific surface area both of less than 450 m²/g, preferably in a range extending from 30 to 400 m²/g, notably from 60 to 300 m²/g.

Use may be made of any type of precipitated silica, in particular highly dispersible precipitated silicas (HDSs). These precipitated silicas, which may or may not be highly dispersible, are well known to a person in the art and commercially available. Mention may be made, for example, of the silicas described in applications WO 03/016215-A1 and WO 03/016387-A1. Among the commercial HDS silicas, use may notably be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, or the Hi-Sil EZ120G (-D), Hi-Sil EZ160G (-D), Hi-Sil EZ200G (-D), Hi-Sil 243LD, Hi-Sil 210 and Hi-Sil HDP 320G silicas from PPG.

The physical state in which the reinforcing inorganic filler is provided is not important, whether it is in the form of a powder, of micropearls, of granules or else of beads or any other appropriate densified form. Of course, “reinforcing inorganic filler” is also understood also to mean mixtures of different reinforcing inorganic fillers, in particular of silicas as described above.

A person skilled in the art will understand that, as a replacement for the inorganic reinforcing filler described above, a reinforcing filler of another nature may be used, provided that this reinforcing filler of another nature is covered with an inorganic layer such as silica, or includes on its surface functional sites, notably hydroxyl sites, requiring the use of a coupling agent to establish the bond between this reinforcing filler and the diene elastomer. By way of example, mention may be made of carbon blacks partially or completely covered with silica, or carbon blacks modified by silica, such as, without limitation, the fillers of Ecoblack® type of the CRX2000 series or of the CRX4000 series from Cabot Corporation.

A person skilled in the art will know how to adjust the total content of reinforcing filler and its nature according to the use concerned, in particular according to the type of tyre concerned or the type of composition of the tyre. The total content of reinforcing filler is within a range extending from 40 to 200 phr, more preferentially from 45 to 180 phr and more preferentially still from 50 to 160 phr, the optimum being, in a known way, different according to the specific applications targeted.

According to another particular embodiment of the invention, the reinforcing filler is predominantly an inorganic reinforcing filler (preferably silica); preferably, it comprises more than 50% by weight of an inorganic reinforcing filler, such as silica, relative to the total weight of the reinforcing filler. According to this embodiment, the inorganic filler is preferably used in a content within a range extending from 40 to 160 phr, preferably from 40 to 140 phr, more preferably from 60 to 120 phr. Optionally according to this embodiment, the reinforcing filler also comprises carbon black. According to this option, the carbon black is used in a content of less than or equal to 20 phr, more preferentially less than or equal to 10 phr (for example, the carbon black content may be in a range from 0.5 to 20 phr, notably from 1 to 10 phr). Within the ranges indicated, the colouring (black pigmentation agent) and anti-UV properties of carbon blacks are exploited, without otherwise penalizing the typical performance provided by the reinforcing inorganic filler.

In the present disclosure, the BET specific surface area is determined by gas adsorption using the Brunauer-Emmett-Teller method described in “The Journal of the American Chemical Society”, (vol. 60, page 309, February 1938), and more specifically according to a method derived from Standard NF ISO 5794-1, appendix E, of June 2010 [multipoint (5 point) volumetric method−gas: nitrogen−degassing under vacuum: one hour at 160° C.−relative pressure p/po range: 0.05 to 0.17].

For the inorganic fillers, such as silica, for example, the CTAB specific surface values were determined according to Standard NF ISO 5794-1, Appendix G, of June 2010. The process is based on the adsorption of CTAB (N-hexadecyl-N,N,N-trimethylammonium bromide) on the “outer” surface of the reinforcing filler.

In order to couple the reinforcing inorganic filler to the diene elastomer, use may be made, in a well-known way, of an at least bifunctional coupling agent (or bonding agent) intended to provide a satisfactory interaction, of chemical and/or physical nature, between the inorganic filler (surface of its particles) and the diene elastomer. Use is made in particular of organosilanes or polyorganosiloxanes which are at least bifunctional. The term “bifunctional” refers to a compound having a first functional group that is capable of interacting with the inorganic filler and a second functional group that is capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (which may be symmetrical or asymmetrical), such as

bis(3-triethoxysilylpropyl) tetrasulfide, abbreviated to TESPT, sold under the name Si69 by Evonik, or bis (triethoxysilylpropyl) disulfide, abbreviated to TESPD, sold under the name Si75 by Evonik, polyorganosiloxanes, mercaptosilanes, or blocked mercaptosilanes, such as S-(3-(triethoxysilyl)propyl) octanethioate sold by Momentive under the name NXT Silane. More preferentially, the organosilane is an organosilane polysulfide.

Of course, use might also be made of mixtures of the coupling agents described above.

The content of coupling agent in the composition of the invention is advantageously less than or equal to 30 phr, it being understood that it is generally desirable to use as little as possible thereof. Typically, the content of coupling agent represents from 0.5% to 15% by weight, relative to the amount of reinforcing inorganic filler. This content is easily adjusted by a person in the art according to the content of reinforcing inorganic filler used in the composition of the invention.

### I.4. Crosslinking System

The crosslinking system may be any type of system known to a person in the art in the field of rubber compositions for tyres. It can in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used at a preferential content of between 0.5 and 12 phr, preferably from 1 to 10 phr, more preferentially from 1 to 5 phr. The vulcanization accelerator is used in a preferential content of between 0.5 and 10 phr, more preferentially between 0.5 and 5.0 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### I.5. Various Additives

The rubber compositions in accordance with the invention may also include all or some of the usual additives and processing aids known to a person in the art and usually used in rubber compositions for tyres, for instance fillers (other than those mentioned previously), pigments, protective agents, such as antiozone waxes, chemical antiozonants, antioxidants, anti-fatigue agents or reinforcing resins (such as described, for example, in patent application WO 02/10269).

### II. Preparation of the Rubber Compositions

The rubber compositions of the invention can be manufactured in appropriate mixers, using two successive phases of preparation well known to a person in the art: a first phase of thermomechanical working or kneading (“non-productive” phase) at high temperature, up to a maximum temperature of between 110° C. and 200° C., preferably between 130° C. and 185° C. for a period of time generally of between 2 and 10 minutes; followed by a second phase of mechanical working (“productive” phase) down to a lower temperature, typically of less than 120° C., for example between 40° C. and 100° C., during which finishing phase the crosslinking system is incorporated, and everything is then mixed together for a few minutes, for example between 5 and 15 minutes.

The process for preparing such compositions therefore consists, for example, in incorporating into the elastomers, in particular into the vinylaromatic diene elastomer, during the first step (known as “non-productive”), the reinforcing filler, the plasticizing system and the optional other ingredients of the composition with the exception of the crosslinking system, by thermomechanically kneading the whole thing (for example one or more times), until a maximum temperature of between 110° C. and 190° C. is reached; then in cooling everything to a temperature below 100° C.; so as to then incorporate, during the second step (known as “productive”), the crosslinking system and knead the whole thing up to a maximum temperature below 110° C.

The final composition thus obtained can subsequently be calendered, for example in the form of a sheet or of a slab, in particular for a laboratory characterization, or else extruded, for example in order to form a rubber profiled element used in the manufacture of a tyre.

The invention relates to the rubber compositions, rubber articles, tyres and semi-finished products for tyres previously described, both in the green state (that is to say before curing) and in the cured state (that is to say after crosslinking or vulcanization).

### III. Tyre of the Invention

The rubber composition according to the invention may be used in different parts of the tyre, in particular in the crown, the carcass, the area of the bead, the area of the sidewall and the tread (including especially the underlayer of the tread).

The abovementioned features of the present invention, and also others, will be understood more clearly on reading the following description of several examples of implementation of the invention, which are given by way of nonlimiting illustration.

### IMPLEMENTATIONAL EXAMPLES OF THE INVENTION

### Measurements and Tests Used

### Size-Exclusion Chromatography

The SEC (Size Exclusion Chromatography) technique makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards via a “Moore” calibration.

### Procedure

The number-average molar mass (Mn), the weight-average molar mass (Mw) of the constituents which can be used in the compositions in accordance with the invention are determined in a known manner, by conventional size exclusion chromatography (SEC) with RI detection and PS (polystyrene) calibration. The PS standards are derived from the PSS-kitr11 kit from PSS-Polymers.

In order to determine the average molar masses, use is made of the 1.5 g/l solution of the sample previously prepared and filtered on a 0.45 μm PTFE filter, which is injected into the chromatographic system. The equipment used is a Waters Alliance e2695 chromatographic line with a Waters RI 410 detector. The elution solvent is tetrahydrofuran, the flow rate is 1 ml·min⁻¹, the temperature of the system is 35° C. and the analytical time is 50 min. Four Agilent columns are used (2 PLGEL 5 μm Mixed-D and 2 PLGEL 3 um Mixed-E). The volume of the sample solution injected is 100 μl.

The software for processing the chromatographic data is the Waters Empower system.

### Differential Calorimetry

The glass transition temperatures (Tg) of the elastomers are determined using a differential scanning calorimeter according to Standard ASTM D3418 (1999).

### Hysteresis

The strain hysteresis is measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to Standard ASTM D 1349-99, is recorded. A strain amplitude sweep is carried out from 0.1% to 100% peak-to-peak (outward cycle) and then from 100% to 0.1% peak-to-peak (return cycle). The result made use of is the loss factor tan(δ). For the return cycle, the maximum value of tan δ observed, denoted tan δ max, is indicated. This value is representative of the hysteresis of the material and in the present case gives the tendency of the rolling resistance: the smaller the value of tan δ max, the lower the hysteresis and, consequently, the rolling resistance. In the examples, the results are given in base 100.

### Plasticizers

The biobased plasticizers based on estolides of ricinoleic acid were obtained according to the following protocols:

### A—Estolide of Ricinoleic Acid Esterified with Isostearyl Alcohol (Oil No. 1) Reaction Scheme (Oil No. 1)

The plasticizer based on ricinoleic acid estolide was obtained according to the following protocol:

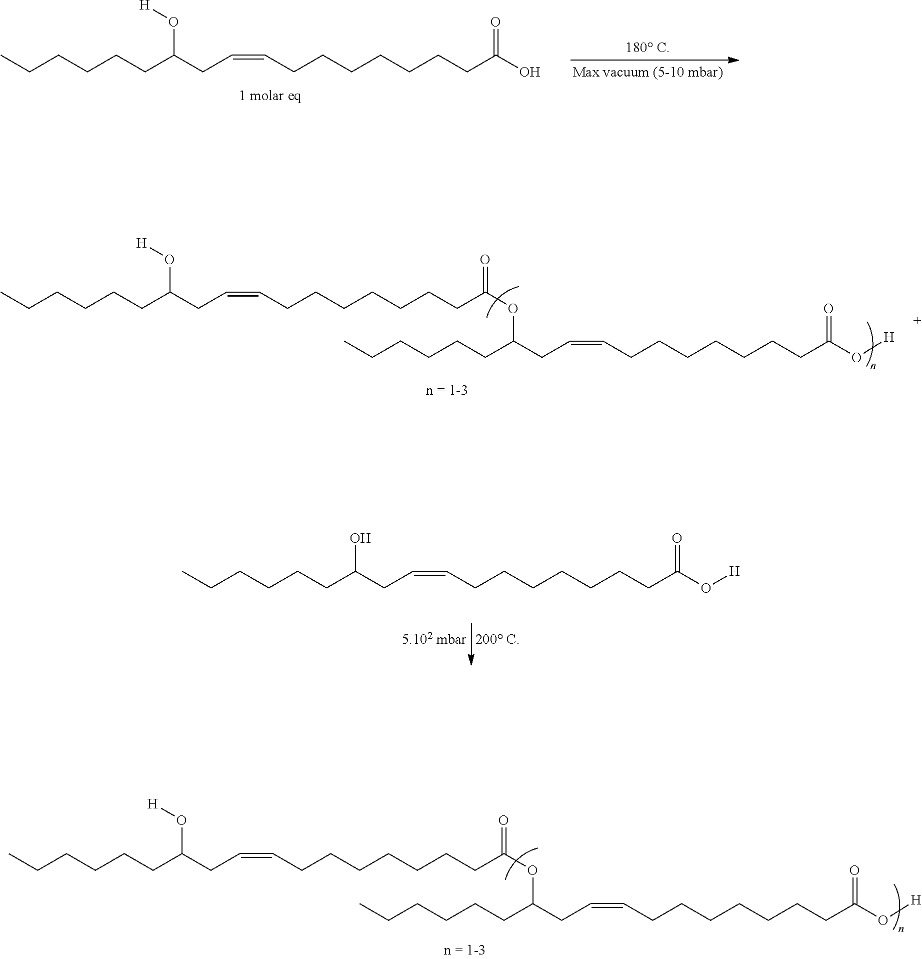

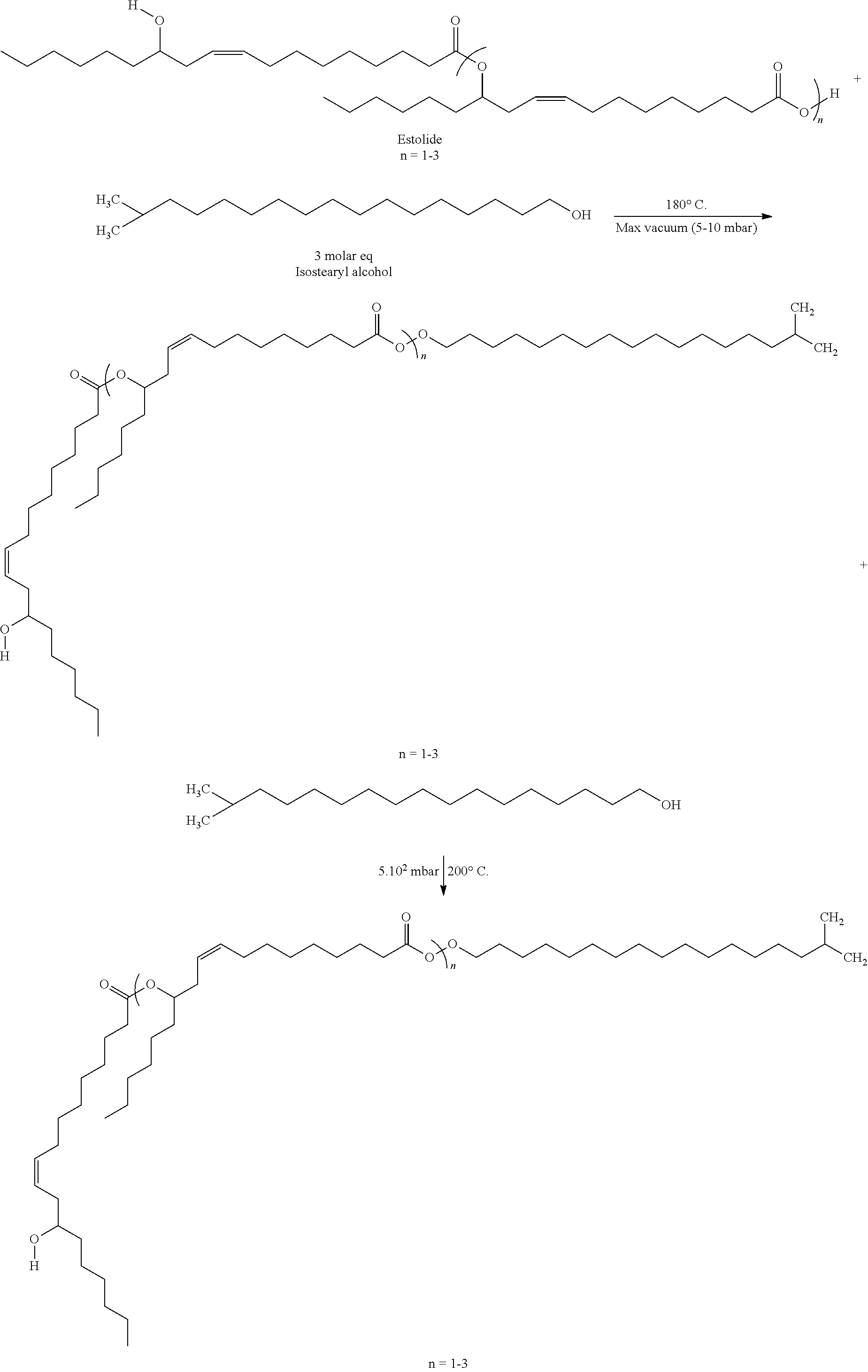

### Protocol

The production of the esterified estolide was carried out in four steps. The first consisted in synthesizing an estolide with a well-defined structure, between 2 and 4 sequences of ricinoleic acid units. The second step consisted in distilling the excess acid present in the medium using molecular distillation. The esterification of the available acid functions on the estolide was then carried out with an excess of isostearyl alcohol. Finally, the last step consisted in distilling the excess alcohol that had not reacted.

### Step 1: Synthesis of the Oligomer

### Procedure

Stirred batch reactor
Conditions: 180° C./600 mbar/14 h
Analytical monitoring: SEC (PS equivalent)

### Step 2: Short-Path Molecular Distillation

### Conditions

Trap temp.: −22° C.
Addition pump speed: 230 ml/h
Jacket temp.: 200° C.
Vacuum: 5×10⁻² mbar
Analytical monitoring: SEC (PS equivalent)

### Step 3: Esterification of the Acid Functions

Addition of 3 molar eq. of isostearyl alcohol

### Procedure

Stirred batch reactor
Conditions: 160° C./under vacuum to distil the water formed during the reaction
Analytical monitoring: Acid value according to Standard NF EN ISO 660 and SEC (PS equivalent)

### Step 4: Short-Path Distillation of Excess Alcohol

### Conditions

Trap temp.: −22° C.
Addition pump speed: 230 ml/h
Jacket temp.: 200° C.
Vacuum: 8.7×10-2 mbar
Analytical monitoring: SEC (PS equivalent)

### B—Estolide of Ricinoleic Acid Esterified with a C₃₆ Diol Dimer (Oil No. 2) Reaction scheme (Oil No. 2)

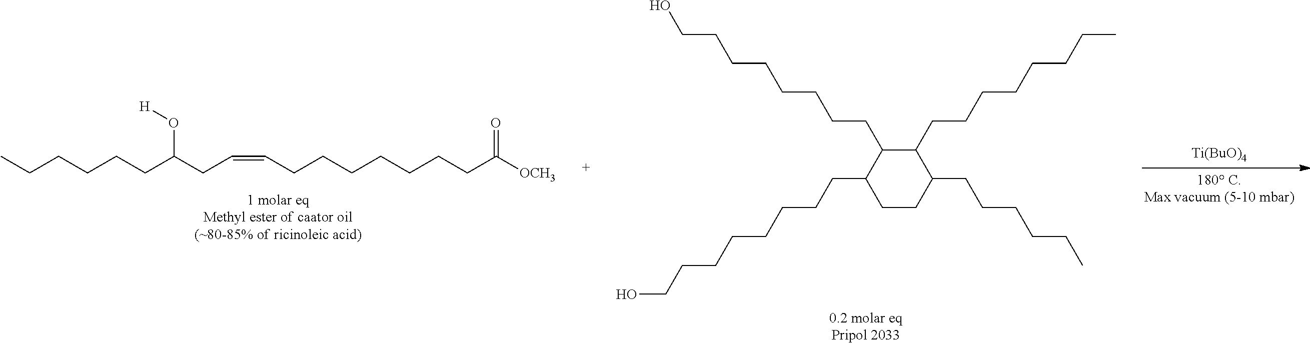 [SMILES: CCCCCCC(O)C/C=C\CCCCCCCC(=O)OC ; CCCCCCCCC1C(CCCCCC)CCC(CCCCCCCCO)C1CCCCCCCCO]

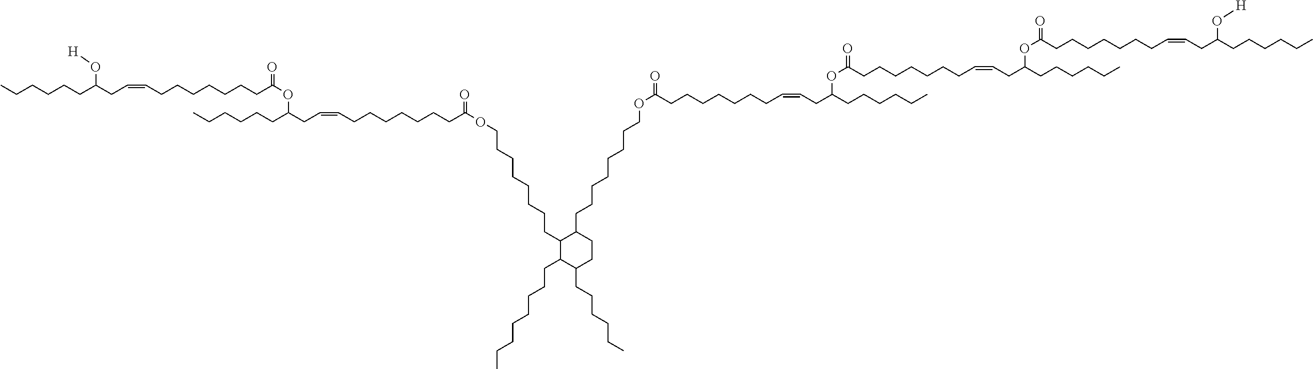 [SMILES: CCCCCCCCC1C(CCCCCC)CCC(CCCCCCCCOC(=O)CCCCCCC/C=C\CC(CCCCCC)OC(=O)CCCCCCC/C=C\CC(CCCCCC)OC(=O)CCCCCCC/C=C\CC(O)CCCCCC)C1CCCCCCCCOC(=O)CCCCCCC/C=C\CC(CCCCCC)OC(=O)CCCCCCC/C=C\CC(O)CCCCCC]

### Protocol

The production of the esterified estolide was carried out in a single step. This is a polycondensation reaction of methyl ricinoleate produced from the castor oil and the Pripol 2033 diol.

### Procedure

Stirred batch reactor
Conditions: 180° C./max vacuum/30 h
Catalysis: 1 wt. % Ti (BuO)₄
Distillation of the MeOH formed during the reaction
Analytical monitoring: SEC (PS equivalent)

The table below gives the weight-average molar mass (Mw) and glass transition temperature (Tg) characteristics of the two biobased oils in accordance with the invention compared to the non-biobased oil (MES oil).

TABLE 1

| Components | Nature | Tg (° C.) | Mw (g/mol) |
|---|---|---|---|
| TDAE oil (10) | Paraffinic | −52 | 650 |
| HTO oil (11) | Oleic sunflower oil | −87 | 1481 |
| Oil no. 1 (12) | Ricinoleic acid | −68 | 2062 |
| Oil no. 2 (13) | estolide | −73 | 3750 |

### Compositions

The “reference” composition T1 is presented in the table below and it comprises a TDAE oil that is of fossil origin. Another reference composition T2 is used comprising an oleic sunflower oil, which is thus biobased, already widely described as a plasticizer for rubber compositions for tyres.

It should be noted that compositions C1 and C2, in accordance with the present invention, are formulated so as to be at the same volume dilution in oil (% v) as the control compositions T1 and T2.

The compositions are as follows (in phr).

TABLE 2

| Component | T1 | T2 | C1 | C2 |
|---|---|---|---|---|
| SBR (1) | 100 | 100 | 100 | 100 |
| Black (2) | 3 | 3 | 3 | 3 |
| Silica (3) | 104 | 104 | 104 | 104 |
| Resin (4) | 23 | 23 | 23 | 23 |
| Silane (5) | 8.4 | 8.4 | 8.4 | 8.4 |
| DPG (6) | 2.3 | 2.3 | 2.3 | 2.3 |
| 6PPD (7) | 3.4 | 3.4 | 3.4 | 3.4 |
| TMQ (8) | 1.4 | 1.4 | 1.4 | 1.4 |
| Wax (9) | 2.3 | 2.3 | 2.3 | 2.3 |
| TDAE oil (10) | 27.5 | | | |
| HTO oil (11) | | 27.5 | | |
| Oil no. 1 (12) | | | 27.5 | |
| Oil no. 2 (13) | | | | 27.5 |
| ZnO (14) | 0.9 | 0.9 | 0.9 | 0.9 |
| Stearic acid (15) | 3 | 3 | 3 | 3 |
| Acc (16) | 2.3 | 2.3 | 2.3 | 2.3 |
| Sulfur | 1 | 1 | 1 | 1 |

(1) SBR silanol-functional at the chain end, 27% by weight of styrene and 24 mol %/vinyl BR, Tg of −48° C.;
(2) ASTM N234 black from Cabot
(3) Zeosil1165MP silica from Solvay
(4) Escorez 5600 resin from ExxonMobil
(5) Silane Si69 from Evonik
(6) Diphenylguanidine, DPG, from Akrochem
(7) Santoflex 6PPD antioxidant from Flexsys
(8) TMQ antioxidant Naugard Q from Chemtura
(9) Redezon PWM 43 wax from Repsol
(10) Vivatec 500 oil from British Petroleum
(11) Oleic sunflower oil from Cargill
(12) Oil No. 1: Ricinoleic acid estolide esterified with isostearyl alcohol
(13) Oil No. 2: Ricinoleic acid estolide esterified with a C₃₆ alicyclic diol dimer
(14) Zinc oxide, industrial grade - Umicore
(15) Stearin, Pristerene 4931 from Uniqema
(16) Cyclohexyl-benzothiazole sulfenamide (CBS) accelerator from Akrochem

### Preparation of the Compositions

The rubber compositions, the details of the formulation of which are given in Table 2, were prepared in the following manner:

The elastomer matrix is introduced into an internal mixer (final degree of filling: approximately 70% by volume and blade speed 60 rpm), the initial vessel temperature of which is approximately 70° C. When the temperature reaches 90° C., the carbon black, the silica and the silane are introduced. Then, when the temperature reaches 120° C., the plasticizer and the resin are introduced, followed by the rest of the additives. Thermomechanical working (non-productive phase) is then performed in one step, which lasts in total approximately 3 to 4 min, until a maximum “dropping” temperature of greater than 140° C. is reached. The mixture thus obtained is recovered and cooled, and sulfur and the vulcanization accelerators are then incorporated on a mixer (homofinisher) at 30° C., the whole being mixed (productive phase) for an appropriate time (for example approximately ten minutes).

The compositions thus obtained are subsequently calendered, either in the form of plaques (thickness of 2 to 3 mm) or of thin sheets of rubber and are vulcanized at their optimum at a temperature of 150° C., for the measurements of their physical and dynamic properties, which are set out in Table 3.

### Results

TABLE 3

| Property | Descriptor | T1 | T2 | C1 | C2 |
|---|---|---|---|---|---|
| Hysteresis | Tan δ max return at 23° C. | 100 | 95 | 91 | 86 |

On reading the results obtained, it may be said that the compositions in accordance with the invention make it possible, unexpectedly, to improve the hysteresis properties relative to the control composition T1 comprising an oil of fossil origin customarily used in rubber compositions for tyres. This is because a significant fall is observed in the relative value of tan δ max return at 23° C. for the compositions C1 and C2, which indicates a fall in the hysteresis relative to the composition T1.

Moreover and surprisingly, the two compositions in accordance with the invention, C1 and C2 comprising a biobased plasticizer, also make it possible to improve the hysteresis properties relative to the control composition T2 comprising a known biobased oil as plasticizer for rubber compositions for tyres. This is because a significant fall is observed in the relative value of tan δ max return at 23° C. for the compositions C1 and C2, which indicates a fall in the hysteresis relative to the composition T2.

1-15. (canceled)

16. A rubber composition based on at least:
an elastomer matrix;
40 to 200 phr of a reinforcing filler;
10 to 140 phr of a plasticizing system comprising at least one estolide with a weight-average molar mass Mw of less than 5000 g/mol determined by size exclusion chromatography; and
a crosslinking system.

17. The rubber composition according to claim 16, wherein the elastomer matrix comprises at least one butadiene elastomer selected from the group consisting of polybutadienes and copolymers of butadiene and of styrene and mixtures thereof.

18. The rubber composition according to claim 16, wherein the elastomer matrix predominantly comprises at least one butadiene elastomer selected from the group consisting of polybutadienes and copolymers of butadiene and of styrene and mixtures thereof.

19. The rubber composition according to claim 16, wherein the reinforcing filler predominantly comprises silica in a content within a range extending from 40 phr to 120 phr.

20. The rubber composition according to claim 16, wherein the content of the at least one estolide is within a range extending from 5 to 70 phr.

21. The rubber composition according to claim 16, wherein the at least one estolide is an estolide of a linear or branched, saturated or unsaturated C₁₂ to C₂₂ hydroxy fatty acid.

22. The rubber composition according to claim 16, wherein the at least one estolide is an estolide esterified with a linear or branched, saturated or unsaturated C₈ to C₃₄ fatty alcohol.

23. The rubber composition according to claim 16, wherein the at least one estolide is an estolide esterified with a fatty alcohol having a branched aliphatic C₁₂ to C₂₂ carbon chain.

24. The rubber composition according to claim 16, wherein the at least one estolide is an estolide esterified with a diol dimer.

25. The rubber composition according to claim 24, wherein the diol dimer is a saturated or unsaturated alicyclic diol dimer.

26. The rubber composition according to claim 24, wherein the diol dimer is a C₃₆ diol dimer.

27. The rubber composition according to claim 16, wherein the at least one estolide corresponds to formula I 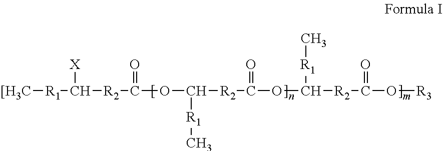
in which:
n represents an integer ranging from 1 to 5;
m is equal to 1 or 2;
X is a hydrogen atom H or a hydroxyl group-OH;
R₁, which may be identical or different, represent linear or branched, saturated or unsaturated, divalent aliphatic C₁-C₂₀ radicals;
R₂, which may be identical or different, are linear or branched, saturated or unsaturated, divalent aliphatic C₁-C₂₀ radicals;
the number of carbons in each fatty acid unit being within a range extending from 8 to 34;
when m is equal to 1, R₃ represents a hydrogen atom or a linear or branched, saturated or unsaturated aliphatic C₈-C₃₄ group; and
when m is 2, R₃ represents a cyclic or acyclic, saturated or unsaturated, divalent aliphatic group.

28. A finished or semi-finished rubber article comprising the rubber composition according to claim 16.

29. A tire comprising the rubber composition according to claim 16.

30. The tire according to claim 29, wherein the tread comprises the rubber composition.
